(19) United States
(12) Patent Application Publication
(10) Pub. No.: US 2004/0099204 A1
(43) Pub. Date: May 27, 2004

(54) Sheet, page, line, position marker

(76) Inventor: John J. Nestor, Laguna Niguel, CA (US)

Correspondence Address: John J. Nestor, 53 Dunn Street, Laguna Nlguel, CA, 92677, US

(21) Appl. No.: 10/302,509

(22) Filed: Nov. 25, 2002

(51) Int. Cl. B42D 9/00

(52) U.S. Cl. 116/236

(57) ABSTRACT

A clasp comprised of an indicator and memo space to be securely placed on a sheet of a printed document at a specific location desired by the user, as a in a book between pages on a specific line. Said sheet of paper can range from tissue paper to 20 pound bond to 80 pound text. The material comprising said clasp is durable and flexible. It is engineered to protect the paper from damage, and designed for ease of use, and safe handling.

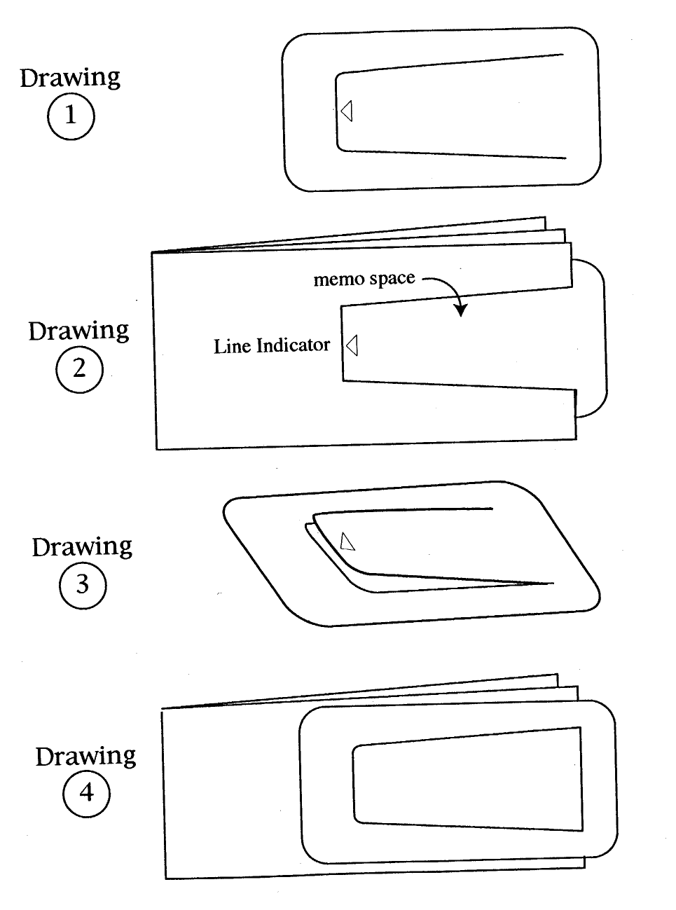

This invention is a combined clasp, divider and memo for use to indicate a specific location on a printed page, such as a document, ledger, legal brief, or book.

### SPECIFICATIONS

The Perfect Marker is an easily removable clasp comprised of an indicator and memo space to be placed between sheets of a printed document at a specific location on a sheet of paper, as in a book, or stapled document, ledger, legal brief, or single sheet of paper. Said sheets of paper can range from tissue paper to 20 pound bond to 80 pound text. The material comprising said clasp is durable, flexible 0.010 opaque vinyl plastic, or other suitable material, designed to protect the sheet of paper from damage both in normal use, or should a book ledger, or document be accidentally dropped. The gripping action of clasp with 0.25″ rounded corners is generated by the difference in its outer borders, and the inner peninsula's border. Said clasp will be exposed 0.25″ from the edge of the document, ledger, or book leaf. The clasp can contain an advertising logo or message.

[image]

Strong, durable, flexible material, such as vinyl plastic, but not limited to vinyl plastic, which bends if hit with force as to protect the book page from damage. The material is consistent to accept printing for identification, or advertising logos and messages. This invention is safe and easy to use.

### SUMMARY OF PRIOR ART

Heretofore, numerous and various clasps and markers ranging from paper to metal, to cloth have been used as dividers and book markers. However, said clasps and markers are cumbersome fail to mark a specific line or place on a sheet and lacking in use, such as falling out of the document, books, and from a single sheet of paper, and often damaging said items during normal use. This present invention has eliminate the aforementioned disadvantages of other clasps and markers, because the indictor/memo/clasp's gripping power is achieved by a variable ratio of tinsel strength of the composite material in relationship between the outer border to the inner peninsula of said clasp. This invention is durable and flexible and engineered to stand up to daily use while protecting the clasped sheet of paper from abnormal impact.

This present invention is always visible while being unobtrusive.

This present invention's memo space offers an additional and practicable function for the user.

### DESCRIPTION OF DRAWINGS

DRAWING 1, is a detailed plan of this present invention. Drawing 1 shows the precise dimensions from top view, front view and side view.

DRAWING 2 shows this present invention in use.

DRAWING 3 is a perspective drawing of this present invention with its peninsula raised ready to insert in the desired location.

DRAWING 4 shows a view of this present invention's back side.

Referring to Drawing 1; this present invention is die cut from a a sheet of 0.010 opaque vinyl plastic to the exact dimensions of said drawing.

Referring to Drawing 3; this present invention, when held between the thumb and the third finger and gently squeezed will conveniently raise the peninsula for ease of insertion to grip the desired sheet of paper.

What is claimed as:

1. a removable clasp comprised of an indicator and memo space to be placed between sheets of a printed document at a specific location on a sheet of paper, as in a book, or stapled document, ledger, legal brief, or single sheet of paper. Said sheets of paper can range from tissue paper to 20 pound bond to 80 pound text. The material comprising said clasp is durable, flexible 0.010 opaque vinyl plastic, or other suitable material, designed to protect the sheet of paper from damage both in normal use, or should a book ledger, or document be accidentally dropped. The gripping action is generated by the difference in the pressure of its outer and inner borders. The clasp can contain an advertising logo or message.
